(19) United States
(12) Patent Application Publication
(10) Pub. No.: US 2014/0230192 A1
(43) Pub. Date: Aug. 21, 2014

(54) Angle changer

(71) Applicant: Orest Llagaci, Westwood, MA (US)

(72) Inventor: Orest Llagaci, Westwood, MA (US)

(21) Appl. No.: 13/442,748

(22) Filed: Feb. 19, 2013

(51) Int. Cl. E05D 5/02

(52) U.S. Cl. CPC E05D 5/02
USPC 16/374

(57) ABSTRACT

The angle changer is a piece of material that can be plastic, metallic, etc. By being placed between End Pieces and Temples next to hinges on sunglasses, it will change the opening of the temples.

An angle changer is a piece of material that can change the angle between two parts of an object. You can change the way sunglasses fit by changing the material or thickness of an angle changer. An angle changer can be glues, magnetically, etc . . .

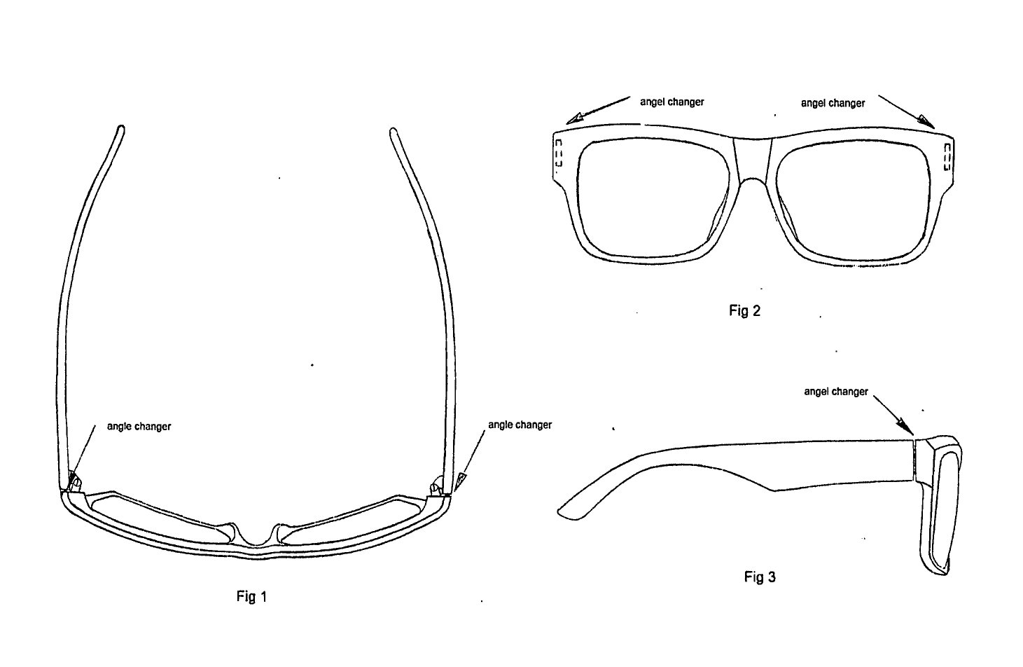

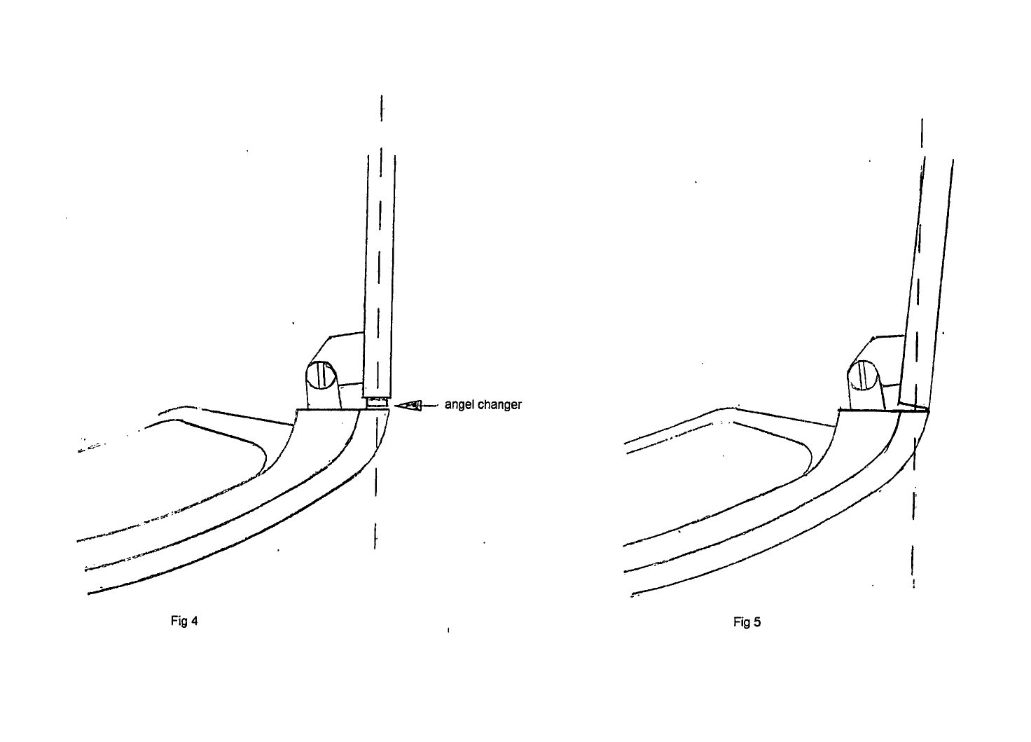

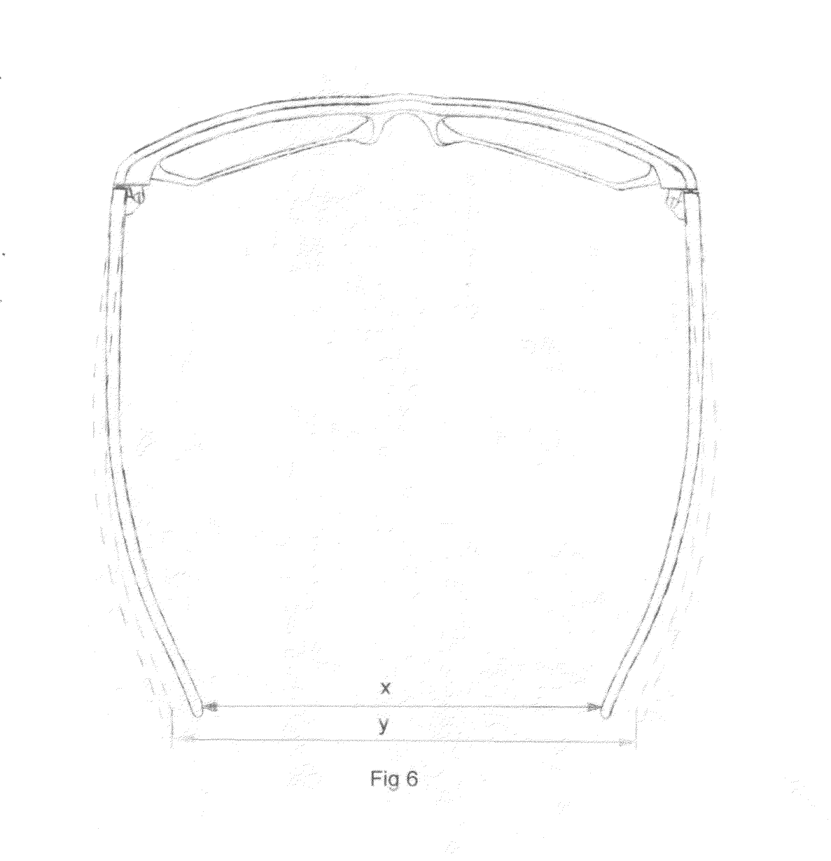

FIGS. 1, 2, and 3 show the place where you would put the angle changer. FIG. 5 shows a poor fit in a pair of sunglasses. In FIG. 4, you can see that by placing an angle changer, it makes the sunglasses have a better fit. In FIG. 6, y is the opening of a poor fit of sunglasses. By placing an angle changer you can see opening x, which makes the sunglasses have a much better fit. The angle changer is not limited only for sunglasses.

I swear on the best of my knowledge that I'm the inventor of the angle changer.

1. A movement restricting element:
a—An element placed between two parts that limit the angle of opening or closing.
b—By changing the ingredients of the element it changes the tolerance on the movement.
